(19) United States
(12) Patent Application Publication
(10) Pub. No.: US 2023/0253735 A1
(43) Pub. Date: Aug. 10, 2023

(54) CONNECTOR ASSEMBLY WITH AN UNSEATED TERMINAL DETECTION FEATURE

(71) Applicant: Aptiv Technologies Limited, St. Michael (BB)

(72) Inventors: RANGARAJAN SUNDARAKRISHNAMACHARI, Chennai (IN); SIDDHAN MANICKAM, Salem (IN); DINESHKUMAR MANOHARAN, Chennai (IN); JOHN SCHNEIDER, Warren, OH (US)

(21) Appl. No.: 18/104,485

(22) Filed: Feb. 1, 2023

Related U.S. Application Data
(60) Provisional application No. 63/308,698, filed on Feb. 10, 2022.

(51) Int. Cl. H01R 13/639; H01R 13/627

(52) U.S. Cl. CPC H01R 13/639; H01R 13/6275

(57) ABSTRACT

An electrical connector assembly includes a connector body defining a terminal cavity in which an electrical terminal is received which has a flexible primary terminal lock arm configured to secure the terminal within the cavity and which has a tab extending from a free end of the primary terminal lock arm. The assembly further includes an independent secondary lock (ISL) defining a window therein, attached to the connector body, and movable from a pre-staged position to a staged position. The tab of the primary terminal lock arm is received within the window when the primary terminal lock arm is in an unflexed condition when the ISL is in the staged position. The tab and window cooperate to inhibit flexing of the primary terminal lock arm when the ISL is in the staged position. Alternatively, the primary terminal lock arm may define the window and the ISL may define the tab.

### CROSS-REFERENCE TO RELATED APPLICATION

This application claims benefit of priority to U.S. Provisional Application No. 63/308,698 filed on Feb. 10, 2022, the entire disclosure of which is hereby incorporated by reference.

### TECHNICAL FIELD

This provisional patent application is directed to a connector assembly with a feature which may be used to detect whether a terminal in the connector assembly is unseated, i.e., not properly positioned, within the connector.

### BACKGROUND

In automotive connectors, an independent secondary lock (ISL) is used to back up the primary terminal lock arm used to retain a terminal within a connector. The ISL is positioned in a pre-staged position that allows the primary terminal lock arm to flex as the terminal is inserted within the connector housing. The ISL is then moved to a staged position after terminal insertion that inhibits flexing of the primary terminal lock arm. ISL provides a positive stop which acts as a backup in addition to the primary terminal lock arm.

In addition to backing up the primary terminal lock arm, the ISL may also be used to detect unseated and/or partially seated terminals. Prior to engagement of the connector with a mating connector, it is desirable to verify that the terminals are fully seated and secured in place to ensure proper connection between the terminals and mating terminals. If the terminal is not properly seated, there is a possibility of terminal to push out of the connector and/or the terminal may not meet the terminal wipe, i.e., overlap, requirements with the mating terminal.

In conventional connectors, the arrangement of the ISL does not allow the ISL to shift from the pre-staged position to the staged position when the terminal is unseated or partially seated. In the case of miniature connectors, e.g., miniature coaxial connectors, the stroke length to move the ISL from the pre-staged position to the staged position is short. This conventional ISL arrangement does not provide reliable feedback to an assembly operator to detect the unseated or partially seated terminals. Due to the small size of miniature coaxial connectors, the options are limited to provide robust terminal unseat detection and many current miniature coaxial connectors do not have unseat detection features.

A solution to detect unseated or partially seated terminals in connectors that have an ISL with a short stroke length is presented herein. A connector includes a lock finger that is designed in such a way that it does not allow the ISL to shift to the staged position if the terminal is partially seated.

### BRIEF SUMMARY

In some aspects, the apparatus described herein relates to an electrical connector assembly, including: a connector body defining a terminal cavity in which an electrical terminal is received and having a flexible primary terminal lock arm configured to secure the terminal within the cavity and having a tab extending from a free end of the primary terminal lock arm; and an independent secondary lock defining a window therein, attached to the connector body, and movable from a pre-staged position to a staged position, the tab of the primary terminal lock arm is received within the window when the primary terminal lock arm is in an unflexed condition when the independent secondary lock is in the staged position. The tab and window cooperate to inhibit flexing of the primary terminal lock arm when the independent secondary lock is in the staged position.

In some respects, the apparatus described herein relates to an electrical connector assembly, in which the tab and window are misaligned when the flexible primary terminal lock arm is in a flexed condition, thereby preventing the independent secondary lock from moving from the pre-staged position to the staged position due to interference between the tab and the independent secondary lock.

In some respects, the apparatus described herein relates to an electrical connector assembly, in which the tab and window are sized, shaped, and arranged such that the tab is received within the window only when the primary terminal lock arm is in an unflexed condition.

In some respects, the apparatus described herein relate to an electrical connector assembly, in which the independent secondary lock defines a pair of tangs located on opposite sides of the independent secondary lock that engage a pair of indentations in the connector body to secure the independent secondary lock in the staged position.

In some respects, the apparatus described herein relates to an electrical connector assembly, in which the pair of indentations is a pair of grooves formed in the connector body.

In some respects, the apparatus described herein relates to an electrical connector assembly, in which the window is an aperture extending through the independent secondary lock.

In some respects, the apparatus described herein relates to an electrical connector assembly, in which the aperture has a generally rectangular shape.

In some respects, the apparatus described herein relates to an electrical connector assembly, in which the tab has a trapezoidal shape.

In some respects, the apparatus described herein relates to an electrical connector assembly, in which the connector body defines four terminal cavities arranged in a 2 by 2 array and four primary terminal lock arms.

In some respects, the apparatus described herein relates to an electrical connector assembly, in which the electrical connector assembly includes two independent secondary locks arranged on opposite sides of the connector body. Each independent secondary lock defines two separate windows.

In some aspects, the apparatus described herein relates to an electrical connector assembly, including: a connector body defining a terminal cavity in which an electrical terminal is received and having a flexible primary terminal lock arm defining a window in a free end of the primary terminal lock arm and configured to secure the terminal within the cavity and having a tab extending from a free end of the primary terminal lock arm; and an independent secondary lock having a tab extending therefrom, attached to the connector body, and movable from a pre-staged position to a staged position. The tab of the independent secondary lock is received within the window of the primary terminal lock arm when the primary terminal lock arm is in an unflexed condition when the independent secondary lock is in the staged position. The tab and window cooperate to inhibit flexing of the primary terminal lock arm when the independent secondary lock is in the staged position.

In some respects, the apparatus described herein relates to an electrical connector assembly, in which the tab and window are misaligned when the flexible primary terminal lock arm is in a flexed condition, thereby preventing the independent secondary lock from moving from the pre-staged position to the staged position due to interference between the tab and the independent secondary lock.

In some respects, the apparatus described herein relates to an electrical connector assembly, in which the tab and window are sized, shaped, and arranged such that the tab is received within the window only when the primary terminal lock arm is in an unflexed condition.

In some respects, the apparatus described herein relates to an electrical connector assembly, in which the independent secondary lock defines a pair of tangs located on opposite sides of the independent secondary lock that engage a pair of indentations in the connector body to secure the independent secondary lock in the staged position.

In some respects, the apparatus described herein relates to an electrical connector assembly, in which the pair of indentations is a pair of grooves formed in the connector body.

In some respects, the apparatus described herein relates to an electrical connector assembly, in which the window is an aperture extending through the primary terminal lock arm.

In some respects, the apparatus described herein relates to an electrical connector assembly, in which the aperture has a generally rectangular shape.

In some respects, the apparatus described herein relates to an electrical connector assembly, in which the tab has a trapezoidal shape.

In some respects, the apparatus described herein relates to an electrical connector assembly, in which the connector body defines four terminal cavities arranged in a 2 by 2 array and four primary terminal lock arms.

In some respects, the apparatus described herein relates to an electrical connector assembly, in which the electrical connector assembly includes two independent secondary locks arranged on opposite sides of the connector body. Each independent secondary lock defines two separate tabs.

### DESCRIPTION OF THE DRAWINGS

A connector assembly will now be described, by way of example with reference to the accompanying drawings, in which:

FIG. 1 illustrates a perspective view of an electrical connector assembly according to some embodiments;

FIG. 2 illustrates a side view of the electrical connector assembly of FIG. 1 according to some embodiments;

FIG. 3 illustrates an exploded view of the electrical connector assembly of FIG. 1 according to some embodiments;

FIG. 4A illustrates a perspective view of a connector body of the electrical connector assembly of FIG. 1 according to some embodiments;

FIG. 4B illustrates a detail view of a tab defined by a primary terminal lock arm of the connector body of FIG. 4A according to some embodiments;

FIG. 5 illustrates a perspective view of an independent secondary lock (ISL) of the electrical connector assembly of FIG. 1 according to some embodiments;

FIG. 6A illustrates a top view of the electrical connector assembly of FIG. 1 with the ISL in a pre-staged position according to some embodiments;

FIG. 6B illustrates a detail top view of the ISL of FIG. 6A in the pre-staged position according to some embodiments;

FIG. 7A illustrates a top view of the electrical connector assembly of FIG. 1 with the ISL in the pre-staged position and the primary terminal lock arm flexed as a terminal is inserted within the connector body according to some embodiments;

FIG. 7B illustrates a detail top view of the primary terminal lock arm and ISL of FIG. 7A according to some embodiments;

FIG. 8A illustrates a top view of the electrical connector assembly of FIG. 1 with the ISL in a staged position according to some embodiments;

FIG. 8B illustrates a detail top view of the primary terminal lock arm and the ISL of FIG. 8A according to some embodiments;

FIG. 9 illustrates a detail side view of the tab of the primary terminal lock arm properly disposed within an aperture in the ISL according to some embodiments;

FIG. 10 illustrates a cut away end view of the connector showing the position of the primary terminal lock arm and ISL when the terminal is properly seated according to some embodiments;

FIG. 11 illustrates a top view of the electrical connector assembly of FIG. 1 when the terminal is improperly seated according to some embodiments;

FIG. 12 illustrates a cut-away top view of the electrical connector assembly of FIG. 1 when the terminal is improperly seated according to some embodiments;

FIG. 13 illustrates a detail side view of the tab of the primary terminal lock arm and the aperture in the ISL when the terminal is improperly seated according to some embodiments;

FIG. 14 illustrates a cut away end view of the connector showing the position of the primary terminal lock arm and ISL when the terminal is improperly seated according to some embodiments;

FIG. 15A illustrates a perspective view of a connector body of an electrical connector assembly according to some embodiments;

FIG. 15B illustrates a detail view of an aperture defined in a primary terminal lock arm of the connector body of FIG. 15A according to some embodiments;

FIG. 16 illustrates a perspective view of an ISL of the electrical connector assembly defining tabs according to some embodiments;

FIG. 17 illustrates a cross-section view of the tab of the ISL of FIG. 16 properly disposed within the aperture in the primary terminal lock arm of FIG. 15B according to some embodiments;

FIG. 18A illustrates a perspective view of a connector body of an electrical connector assembly according to some embodiments;

FIG. 18B illustrates a detail view of an aperture defined in a primary terminal lock arm of the connector body of FIG. 18A according to some embodiments;

FIG. 19 illustrates a perspective view of an ISL of the electrical connector assembly defining tabs according to some embodiments; and

FIG. 20 illustrates a cross-section view of the tab of the ISL of FIG. 19 properly disposed within the aperture in the primary terminal lock arm of FIG. 18B according to some embodiments.

### DETAILED DESCRIPTION

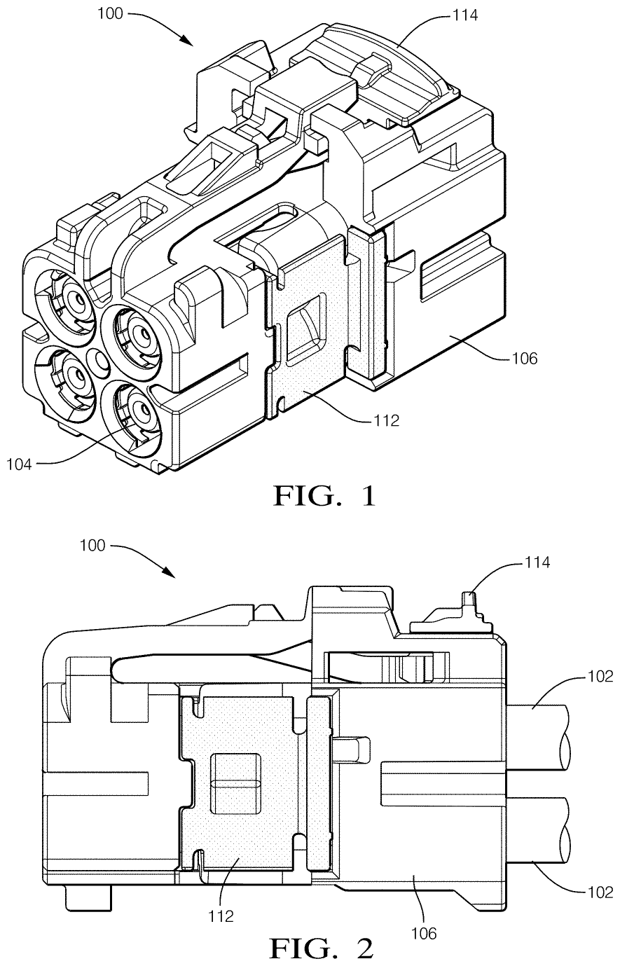

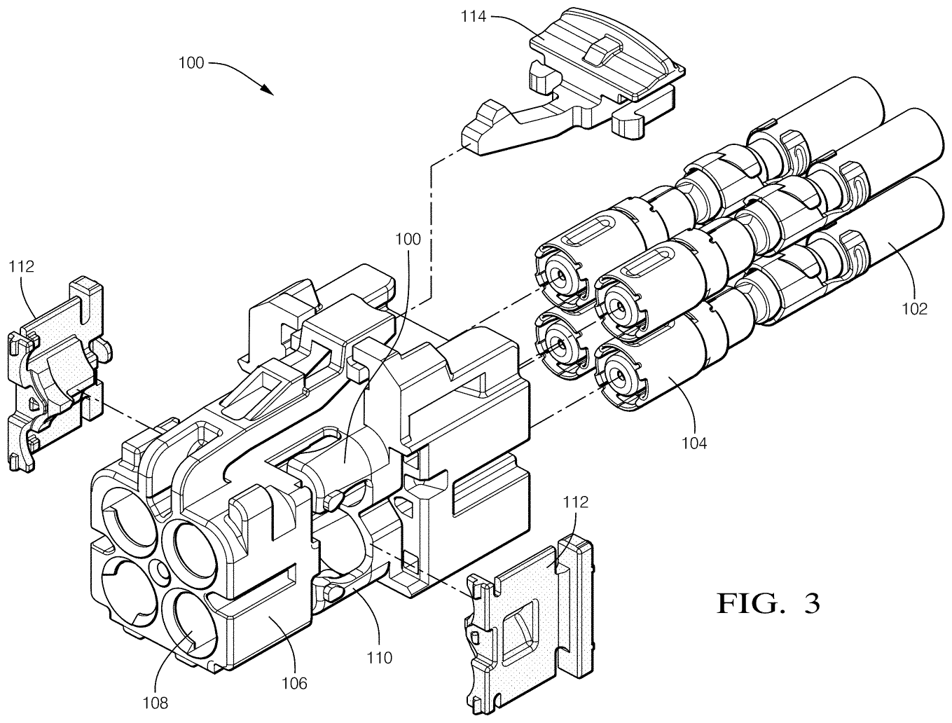

A non-limiting example of an electrical connector assembly 100 having primary and secondary locks is generally shown in FIGS. 1 and 2. The illustrated example in FIG. 3 is a connector assembly 100 for miniaturized coaxial cables that includes four coaxial cables 102 terminated by coaxial terminals 104 and an electrically insulative connector body 106 defining four terminal cavities 108 in which the coaxial terminals 104 are received. The connector body 106 is preferably formed of an electrically insulative engineered polymer. The connector body 106 includes four integrally formed cantilevered primary terminal lock arms 110 arranged in a two by two array that are each configured to secure the coaxial terminals 104 within the terminal cavities 108. Alternative embodiments of the connector assembly may have a single terminal cavity, two terminal cavities, or more than four terminal cavities, preferably arranged in an X by two array.

The primary terminal lock arms 110 have cantilevered flexible arms that allow the terminals 104 to be inserted within the terminal cavities 108 and then snap back to their original position to hold the terminals 104 within the cavities 108. The connector assembly 100 further includes two independent secondary locks (ISLs) 112 that are also configured to secure the coaxial terminals 104 within the terminal cavities 108. The ISLs 112 are also configured to inhibit the primary terminal lock arms 110 from flexing once the terminals 104 are properly seated within the terminal cavities 108. The illustrated connector assembly 100 also includes a connector position assurance (CPA) device 114 that is configured to maintain connection between the connector assembly 100 and a corresponding mating connector assembly (not shown). Alternative embodiments of the connector assembly may be envisioned that do not include the CPA device 114.

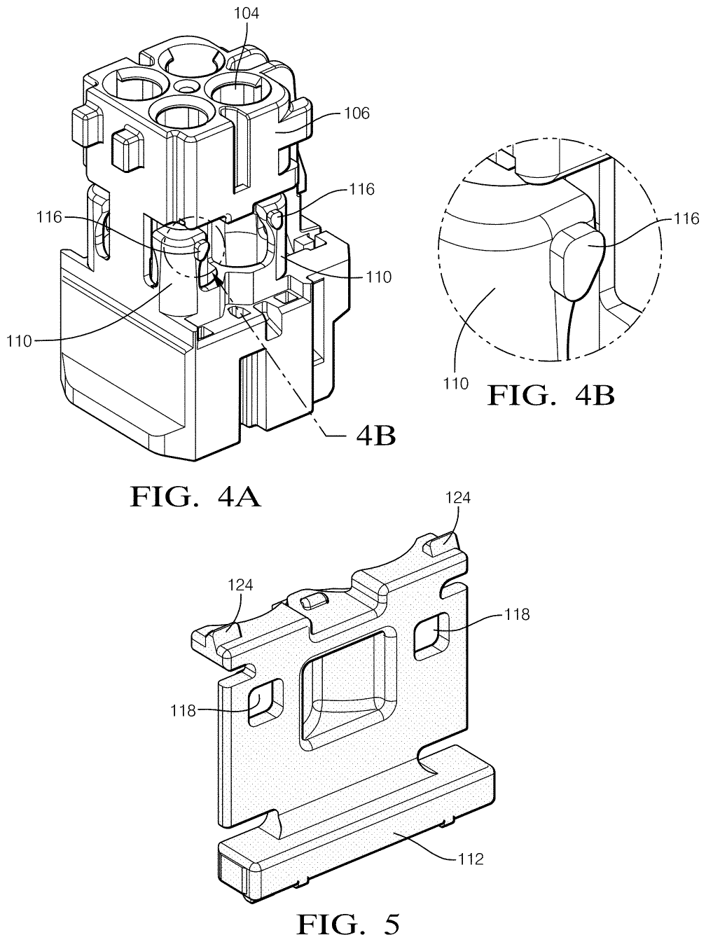

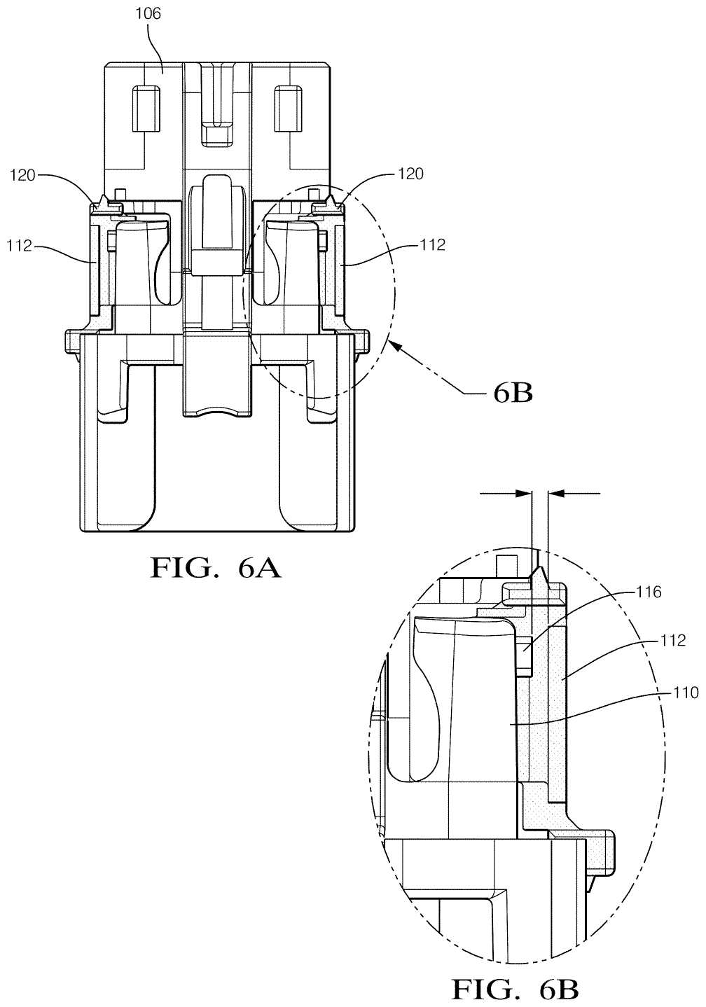

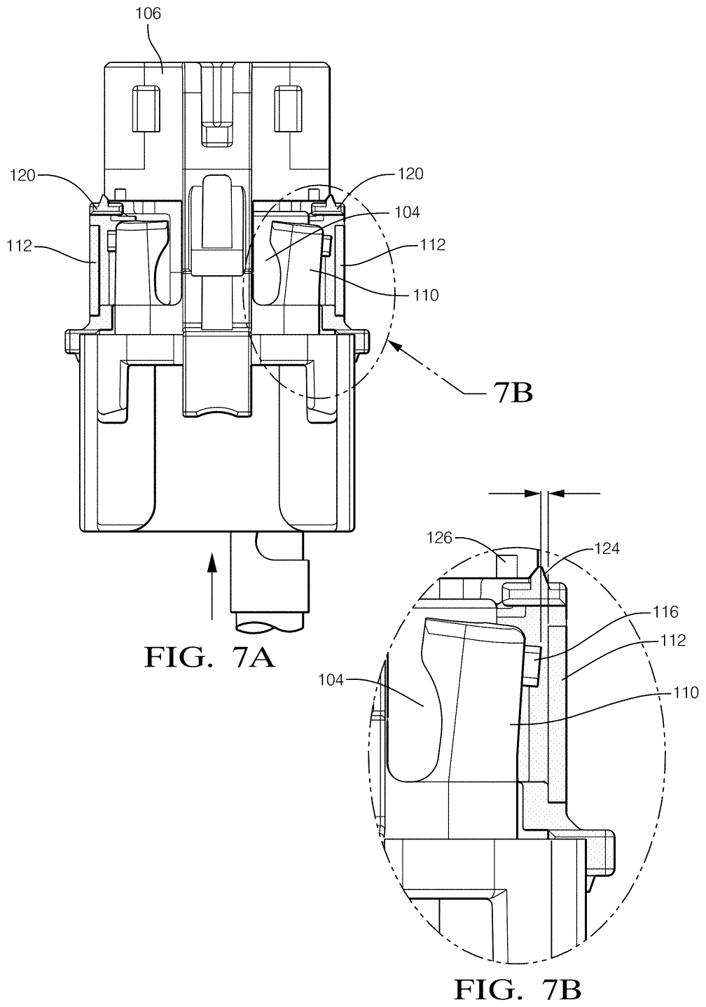

The primary terminal lock arms 110 and ISLs 112 are arranged to detect unseated/partially seated terminals even for connectors with short ISL stroke lengths. The primary terminal lock arms 110 include trapezoidal tabs 116 projecting from a free end of the primary terminal lock arms 110 as shown in FIGS. 4A and 4B. Although the shape of the trapezoidal tabs 116 is preferred, other embodiments of the connector assembly may be envisioned in which the tabs have a rectangular, triangular, round, oval, or one of many other shapes. The ISLs 112 each define a rectangular window 118 as shown in FIG. 5. Although the shape of the pair of rectangular windows 118 is preferred, other embodiments of the connector assembly may be envisioned in which the ISLs define a single rectangular window or two windows having a rectangular, triangular, round, oval, or one of many other shapes. As used herein, each window 118 may be an aperture extending through the ISLs 112 as shown in FIG. 5, or it may be a depression or indentation in an inner surface of the ISLs. In the pre-staged position 120, there is enough clearance between the primary terminal lock arms 110 and the ISLs 112 so that the ISLs 112 do not interfere with or inhibit the flexing of the primary terminal lock arms 110 as the terminals 104 are inserted within the terminal cavities 108, as shown in FIGS. 7A and 7B.

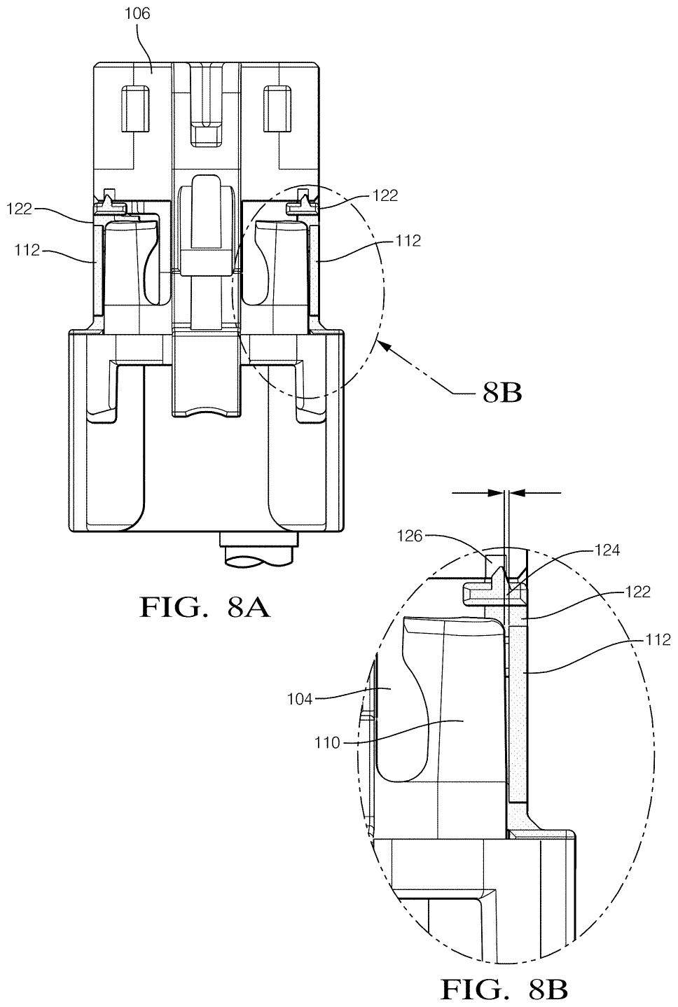

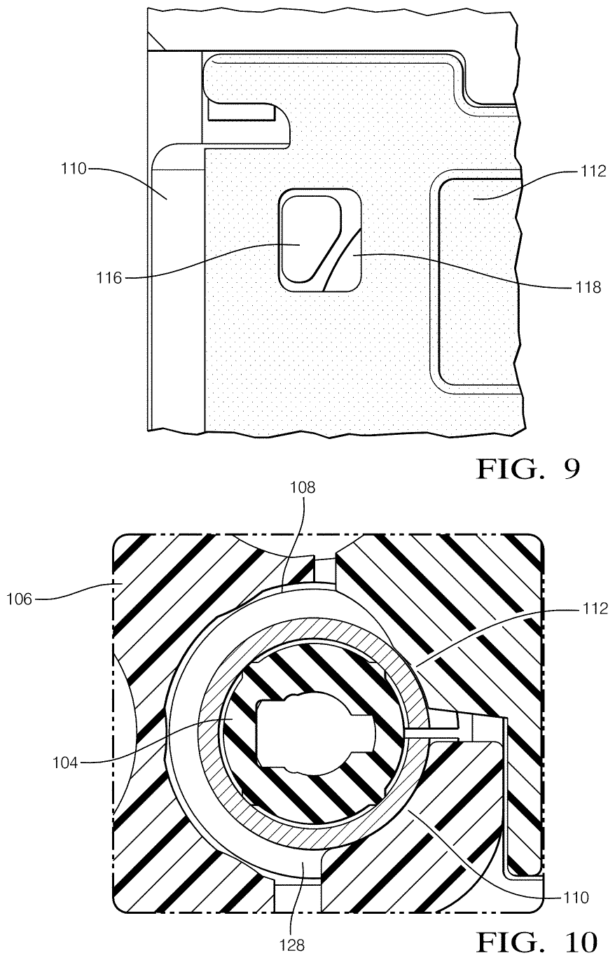

FIGS. 8A and 8B show the condition of the primary terminal lock arms 110 when the terminals 104 are properly seated within the terminal cavities 108 and the ISLs 112 are in a staged position 122. As the ISLs 112 are moved from the pre-staged position 120 to the staged position 122 by a human or machine assembly operator, the tabs 116 are received in the windows 118 in the ISLs 112 as shown in FIG. 9, thereby allowing the ISLs 112 to reach the staged position 122. Once in the staged position 122, tangs 124 on ends of the ISLs 112 are engaged with grooves 126 in the connector body 106 to maintain the ISLs 112 in the staged position 122. In addition, when the terminals 104 are properly seated, the primary terminal lock arms 110 and the ISLs 112 both overlay ends 128 of the terminals 104 as shown in FIG. 10 to secure the terminals 104 within the terminal cavities 108, thereby preventing pull-out of the terminals 104 from the cavities 108.

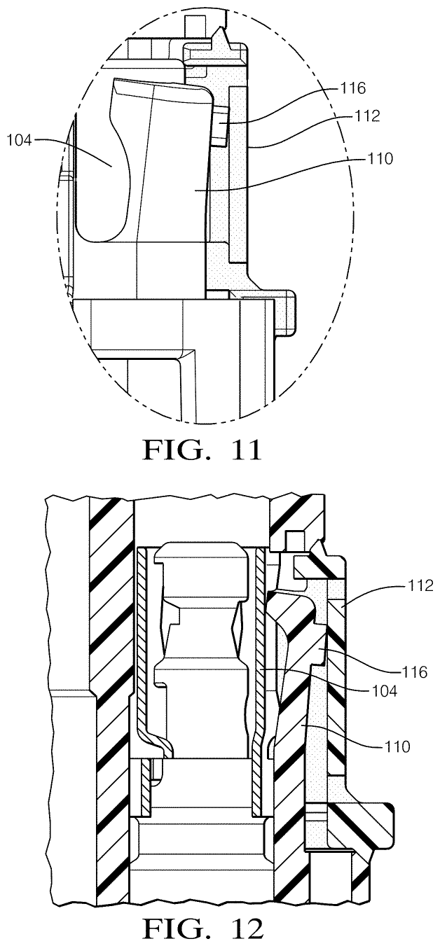

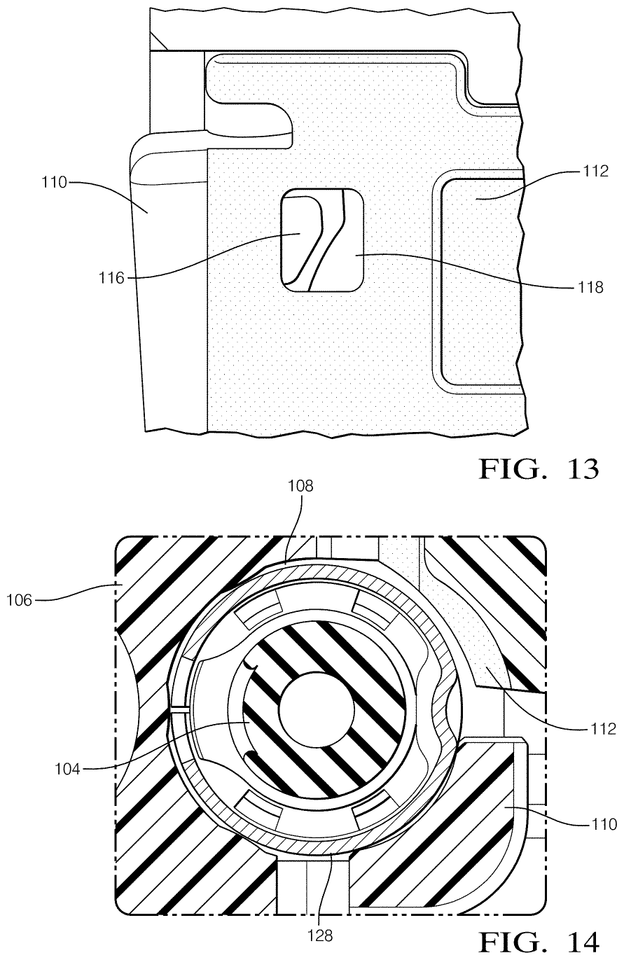

FIGS. 11 and 12 show the condition of the primary terminal lock arms 110 when the terminals 104 are improperly seated within the cavities 108. In this case, the tabs 116 are not aligned with the windows 118 in the ISLs 112 as shown in FIG. 13 and the tabs 116 contact the ISLs 112, thereby interfering with the ISLs 112 and preventing the ISLs 112 from moving from the pre-staged position 120 to the staged position 122. As shown in FIG. 14, when the terminals 104 are improperly seated, the primary terminal lock arms 110 and the ISLs 112 do not overlay the ends 128 of the terminals 104 and may not secure the terminals 104 within the terminal cavities 108.

The blocking of movement of the ISLs 112 from the pre-staged position 120 to the staged position 122 may be tactilely and visually observed by an assembly operator to identify and detect the occurrence of improperly seated terminals. Hence, unseated or partially seated terminals may be detected even in connector assemblies having ISLs with a short stroke.

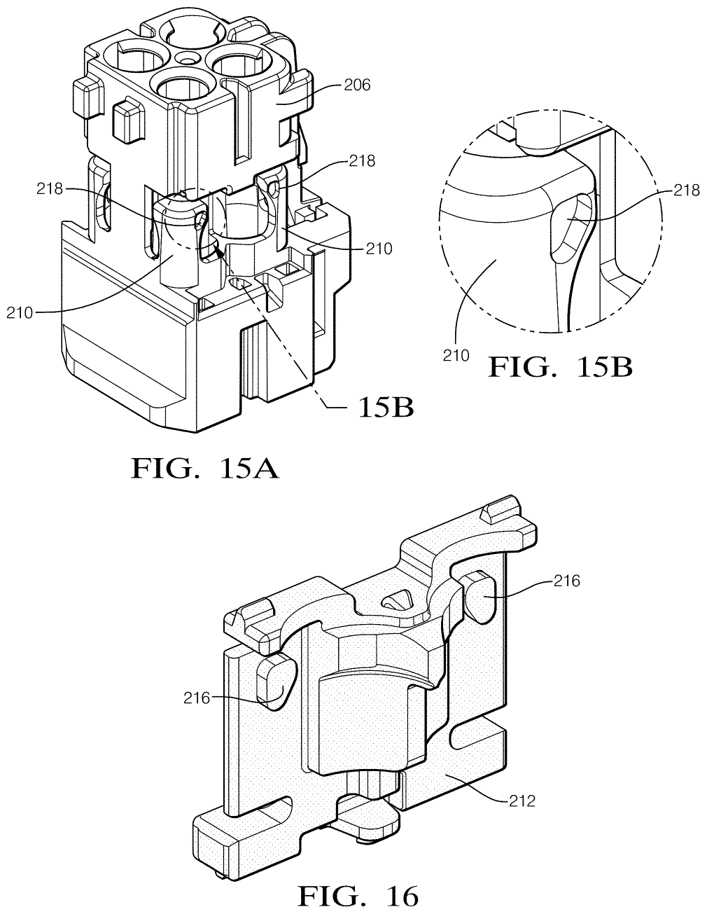

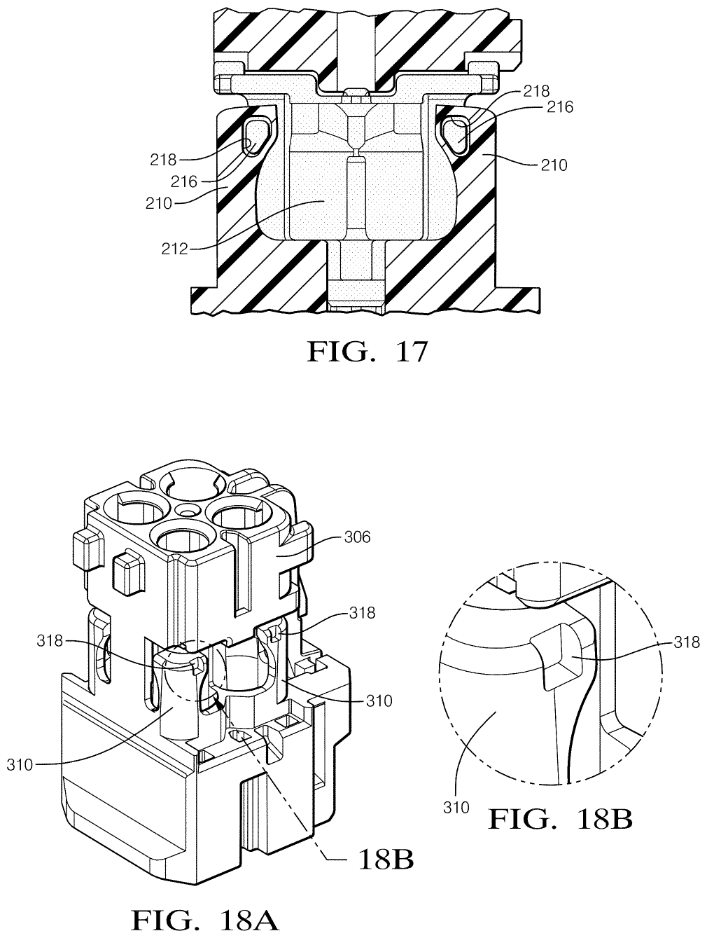

Another embodiment of the connector body and ISL are shown in FIGS. 15A through 17. In the embodiment of the connector body 206 shown in FIGS. 15A and 15B, the primary terminal lock arms 210 define trapezoidal windows 218 in a free end of the primary terminal lock arms 210. As shown in FIG. 16, the ISLs 212 each define trapezoidal tabs 216 projecting from an inner surface of the ISL 212 as shown in FIG. 16. As used herein, each window 218 may be an aperture extending through the primary terminal lock arms 210 as shown in FIGS. 15A and 15B, or it may be a depression or indentation in an outer surface of the primary terminal lock arms. As the ISLs 212 are moved from the pre-staged position to the staged position by a human or machine assembly operator, the tabs 216 are received in the windows 218 in the primary terminal lock arms 210 as shown in FIG. 17.

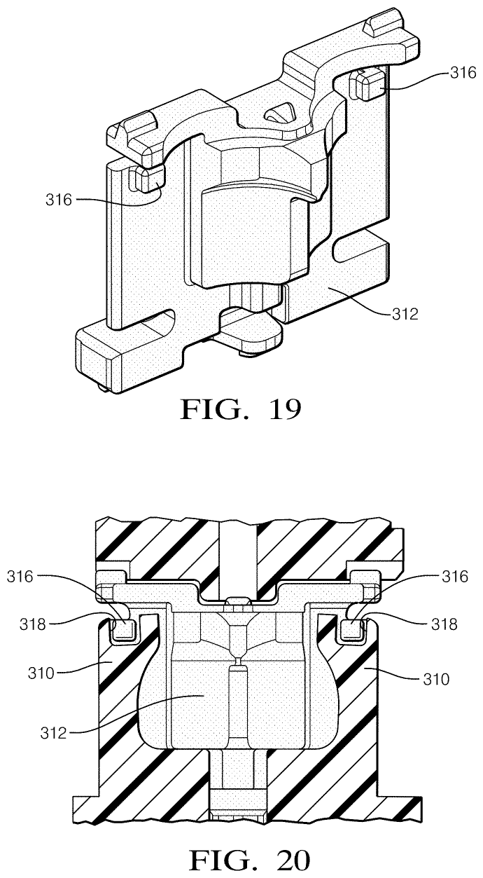

Yet another embodiment of the connector body and ISL are shown in FIGS. 18A through 20. In the embodiment of the connector body 306 shown in FIGS. 18A and 18B, the primary terminal lock arms 310 define rectangular windows 318 in a free end of the primary terminal lock arms 310. As shown in FIG. 16, the ISLs 312 each define rectangular tabs 316 projecting from an inner surface of the ISL 312 as shown in FIG. 19. As used herein, each window 318 may be an aperture extending through the primary terminal lock arms 310 as shown in FIGS. 18A and 18B, or it may be a depression or indentation in an outer surface of the primary terminal lock arms. As the ISLs 312 are moved from the pre-staged position to the staged position by a human or machine assembly operator, the tabs 316 are received in the windows 318 in the primary terminal lock arms 310 as shown in FIG. 20.

Although the combination of shapes of the trapezoidal windows 218 and trapezoidal tabs 216 or rectangular windows 318 and rectangular tabs 316 may be preferred, more alternative embodiments of the connector assembly may be envisioned in which the tabs on the ISL have a triangular, round, oval, or one of many other shapes and the primary lock arms define windows having a triangular, round, oval, or one of many other shapes.

The interface of the tabs 216, 316 on the ISL 212, 312 and windows 218, 318 in the primary terminal lock arms 210, 310 function similarly to the tabs 116 on the primary terminal lock arms 110 and the windows 118 in the ISL 112 and provide similar benefits.

While the example presented herein is directed to a coaxial electrical connector assembly, alternative embodiments of the connector assembly may be envisioned that are configured to interconnect electrical cables, fiber optic cables, pneumatic tubes, hydraulic tubes, or a hybrid connector assembly having a combination of any of these types of conductors.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. An electrical connector assembly, comprising:
a connector body defining a terminal cavity in which an electrical terminal is received and having a flexible primary terminal lock arm configured to secure the terminal within the cavity and having a tab extending from a free end of the primary terminal lock arm; and
an independent secondary lock defining a window therein, attached to the connector body, and movable from a pre-staged position to a staged position, the tab of the primary terminal lock arm is received within the window when the primary terminal lock arm is in an unflexed condition when the independent secondary lock is in the staged position and wherein the tab and window cooperate to inhibit flexing of the primary terminal lock arm when the independent secondary lock is in the staged position.

2. The electrical connector assembly according to claim 1, wherein the tab and window are misaligned when the flexible primary terminal lock arm is in a flexed condition, thereby preventing the independent secondary lock from moving from the pre-staged position to the staged position due to interference between the tab and the independent secondary lock.

3. The electrical connector assembly according to claim 1, wherein the tab and window are sized, shaped, and arranged such that the tab is received within the window only when the primary terminal lock arm is in an unflexed condition.

4. The electrical connector assembly according to claim 1, wherein the independent secondary lock defines a pair of tangs located on opposite sides of the independent secondary lock that engage a pair of indentations in the connector body to secure the independent secondary lock in the staged position.

5. The electrical connector assembly according to claim 4, wherein the pair of indentations is a pair of grooves formed in the connector body.

6. The electrical connector assembly according to claim 1, wherein the window is an aperture extending through the independent secondary lock.

7. The electrical connector assembly according to claim 6, wherein the aperture has a generally rectangular shape.

8. The electrical connector assembly according to claim 1, wherein the tab has a trapezoidal shape.

9. The electrical connector assembly according to claim 1, wherein the connector body defines four terminal cavities arranged in a 2 by 2 array and four primary terminal lock arms.

10. The electrical connector assembly according to claim 1, wherein the electrical connector assembly includes two independent secondary locks arranged on opposite sides of the connector body and wherein each independent secondary lock defines two separate windows.

11. An electrical connector assembly, comprising:
a connector body defining a terminal cavity in which an electrical terminal is received and having a flexible primary terminal lock arm configured to secure the terminal within the cavity and having a window in a free end of the primary terminal lock arm; and
an independent secondary lock having a tab extending therefrom, attached to the connector body, and movable from a pre-staged position to a staged position, wherein the tab of the independent secondary lock is received within the window of the primary terminal lock arm when the primary terminal lock arm is in an unflexed condition when the independent secondary lock is in the staged position and wherein the tab and window cooperate to inhibit flexing of the primary terminal lock arm when the independent secondary lock is in the staged position.

12. The electrical connector assembly according to claim 11, wherein the tab and window are misaligned when the flexible primary terminal lock arm is in a flexed condition, thereby preventing the independent secondary lock from moving from the pre-staged position to the staged position due to interference between the tab and the primary terminal lock arm.

13. The electrical connector assembly according to claim 11, wherein the tab and window are sized, shaped, and arranged such that the tab is received within the window only when the primary terminal lock arm is in an unflexed condition.

14. The electrical connector assembly according to claim 11, wherein the independent secondary lock defines a pair of tangs located on opposite sides of the independent secondary lock that engage a pair of indentations in the connector body to secure the independent secondary lock in the staged position.

15. The electrical connector assembly according to claim 14, wherein the pair of indentations is a pair of grooves formed in the connector body.

16. The electrical connector assembly according to claim 11, wherein the window is an aperture extending through the primary terminal lock arm.

17. The electrical connector assembly according to claim 16, wherein the aperture has a generally rectangular shape.

18. The electrical connector assembly according to claim 11, wherein the tab has a trapezoidal shape.

19. The electrical connector assembly according to claim 11, wherein the connector body defines four terminal cavities arranged in a 2 by 2 array and four primary terminal lock arms.

20. The electrical connector assembly according to claim 11, wherein the electrical connector assembly includes two independent secondary locks arranged on opposite sides of the connector body and wherein each independent secondary lock defines two separate tabs.
